(19) United States
(12) Patent Application Publication
(10) Pub. No.: US 2006/0087926 A1
(43) Pub. Date: Apr. 27, 2006

(54) MP3 player capable of automatic updating, automatic updating system for MP3 player and method thereof

(75) Inventor: Eui Jin Hwang, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: Reigncom Ltd.

(21) Appl. No.: 11/259,551

(22) Filed: Oct. 25, 2005

(30) Foreign Application Priority Data
Oct. 25, 2004 (KR) 10-2004-0085286

(51) Int. Cl. G11B 21/08

(52) U.S. Cl. 369/30.06

(57) ABSTRACT

A system, apparatus and method is provided for detecting a music list stored in a playback device, such as a Moving Picture Experts Group-1 Audio Layer-3 (MP3) player, and selectively downloading from a server to the playback device only updated current music files via the Internet such that the playback device is capable of being automatically updated by the system and method. The playback device may facilitate automatic authentication and transfer of files from the server.

### CROSS-REFERENCE TO RELATED APPLICATIONS

Pursuant to 35 U.S.C. § 119(a), this application claims the benefit of earlier filing date and right of priority to Korean Application No. 10-2004-0085286, filed on Oct. 25, 2004, the contents of which is hereby incorporated by reference herein in its entirety:

### BACKGROUND OF THE INVENTION

1. Field of the Invention

The present invention relates to a system, apparatus and method for detecting a music list stored in a playback device, such as a Moving Picture Experts Group-1 Audio Layer-3 (MP3) player, and selectively downloading only updated current music files to the playback device via the Internet such that the playback device is capable of being automatically updated by the system and method.

2. Description of the Related Art

With the recent development of semiconductor technology, playback devices, such as portable Moving Picture Experts Group-1 Audio Layer-3 (MP3) players, which store music in memory in computer file form and play the stored music, have become popular. Unlike existing portable music players, such as cassette players and CD players, MP3 players can store music without the need to carry separate storage media, such as cassette tapes or music Compact Discs (CDs), so they are easy to carry and durable and have low power consumption because they have no mechanically operated parts.

However, a disadvantage of conventional MP3 players is that in order to store music in computer file form in the MP3 player, users must use an inconvenient method of searching for MP3 files on the Internet and downloading the MP3 files to the MP3 player or converting music stored in another media, such as CDs, into MP3 files using a computer. Specifically, users who are mainly interested in new music or popular music must not only search for or purchase music and download the music, but must also delete previously stored music files from their MP3 player to create storage space for music they download.

Therefore, there is a need for a playback device that facilitates efficiently downloading music files via the Internet such that the playback device is capable of being automatically updated with only those music files the user desires to receive and which automatically deletes unwanted files in order to create storage space for desired files. The present invention addresses these and other needs.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The invention is directed to provide a system, apparatus and method for detecting a music list stored in a playback device, such as a Moving Picture Experts Group-1 Audio Layer-3 (MP3) player, and selectively downloading only updated current music files to the playback device via the Internet such that the playback device is capable of being automatically updated by the system and method. By comparing a list of music files stored in a server to a list of music files stored in the playback device, only those files presently in the server list and not presently in the playback device list may be downloaded and files presently in the playback device list and not presently in the server list may be deleted to create sufficient storage space for the downloaded files.

Accordingly, the present invention has been made keeping in mind the disadvantages of the prior art, and an object of the present invention is to provide a system and method for automatically updating an MP3 player such that when the MP3 player accesses an MP3 server via the Internet terminal, an updated music list of the MP3 server is compared with a stored music list in the MP3 player and only updated music files are selectively sent to the MP3 player.

Additionally, another object of the present invention is to provide an MP3 player that can automatically update music files through the transmission and reception of data to and from an MP3 server over the Internet.

An object of an embodiment of the present invention is to provide a system and method for automatically updating an MP3 player such that when an Internet terminal detects access by the MP3 player, an MP3 server can be automatically accessed without separate manipulation, such as a user's HTTP address input, and updated music files can be transferred.

An object of another embodiment of the present invention is to provide a system and method for automatically updating an MP3 player in which an MP3 server automatically authenticates a user without separate manipulation, such as a user's Id and password input, in such a way that the user's authentication information is stored in an MP3 player and the MP3 player automatically transfers the authentication information upon access to the MP3 server.

An object of still another embodiment of the present invention is to provide a system and method for automatically updating an MP3 player in which an MP3 server can update music lists for various genres and selectively and automatically initiate the download of music files of a genre corresponding to a user's selection.

An object of still another embodiment of the present invention is to provide a system and method for automatically updating an MP3 player in which the MP3 player can rearrange the order of storage of stored music files according to a user's preferences, such as a ranking by popularity.

An object of still another embodiment of the present invention is to provide a system and method for automatically updating an MP3 player that can automatically delete music files that correspond to music files stored only in the MP3 player and which are not included in the updated music list of an MP3 server, thereby ensuring storage space for new files.

In order to accomplish the above object, the present invention provides a system for automatically updating a MP3 player, including an MP3 server for updating and storing a plurality of music files and a music group list and providing the music files over the Internet and an MP3 player for storing music files and creating a stored music list such that the stored music list and the music group list are compared and those music files that are only in the music group list are transferred from the MP3 server to the MP3 player.

The MP3 player may include an authentication information storage unit for storing user authentication information used to access the MP3 server and an Internet terminal for sending and receiving data to and from the MP3 player and accessing the MP3 server via the Internet. The Internet terminal accesses the MP3 server and automatically transfers the user authentication information to the MP3 server when the MP3 player gains access.

Additionally, the present invention provides a method of automatically updating an MP3 player including an MP3 player storing user authentication information used to access an Internet terminal, the Internet terminal accessing an MP3 server, the MP3 server automatically authenticating a user using the user authentication information previously stored in the MP3 player, and the MP3 server comparing a music group list with a music list stored in the MP3 player and transferring music files that are only in the music group list to the MP3 player.

Additionally, the present invention provides an MP3 player including a music file storage unit for storing music files, a stored music list creation unit for creating a list of music files stored in the music file storage unit and an update unit for receiving music files via the Internet from an MP3 server. The MP3 server creates, stores and updates a music group list for a plurality of stored music files, the music files selected for transfer to the MP3 player according to a comparison of the MP3 player stored music list with the MP3 server music group list such that music files that are only in the server music group list are transferred and the update unit updates the music files stored in the music file storage unit.

The MP3 player may include an Internet terminal connection unit for accessing an Internet terminal capable of sending and receiving data to and from the MP3 server via the Internet and an authentication information storage unit for storing user authentication information that is used to access the MP3 server. The MP3 player accesses the MP3 server via the Internet terminal connection unit.

Additional features and advantages of the invention will be set forth in the description which follows, and in part will be apparent from the description, or may be learned by practice of the invention. It is to be understood that both the foregoing general description and the following detailed description of the present invention are exemplary and explanatory and are intended to provide further explanation of the invention as claimed.

These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a diagram illustrating the construction of a system for automatically updating an MP3 player in accordance with an embodiment of the present invention.

FIG. 2 is a diagram illustrating the construction of an MP3 player in accordance with an embodiment of the present invention.

FIG. 3 is a diagram illustrating the construction of an MP3 server in accordance with an embodiment of the present invention.

FIG. 4 is a flowchart illustrating a method of automatically updating an MP3 player in accordance with an embodiment of the present invention.

FIG. 5 is a signal processing diagram illustrating a method of automatically updating an MP3 player in accordance with an embodiment of the present invention.

FIG. 6 is a signal processing diagram illustrating a method of automatically updating an MP3 player in accordance with another embodiment of the present invention.

### DETAILED DESCRIPTION OF THE PREFERRED EMBODIMENTS

The present invention relates to a system, apparatus and method for detecting a music list stored in a playback device and selectively downloading only updated current music files to the playback device via the Internet such that the playback device is capable of being automatically updated by the system and method. Although the present invention is illustrated with respect to a Moving Picture Experts Group-1 Audio Layer-3 (MP3) player, it is contemplated that the present invention may be utilized anytime it is desired to detect files stored in a playback device and download to the playback device only those files that currently reside in a server and which do not currently reside in the playback device.

Reference is made to the drawings in which the same reference numerals are used throughout the different drawings to designate the same or similar components. Embodiments of the present invention are described in detail with reference to the accompanying drawings.

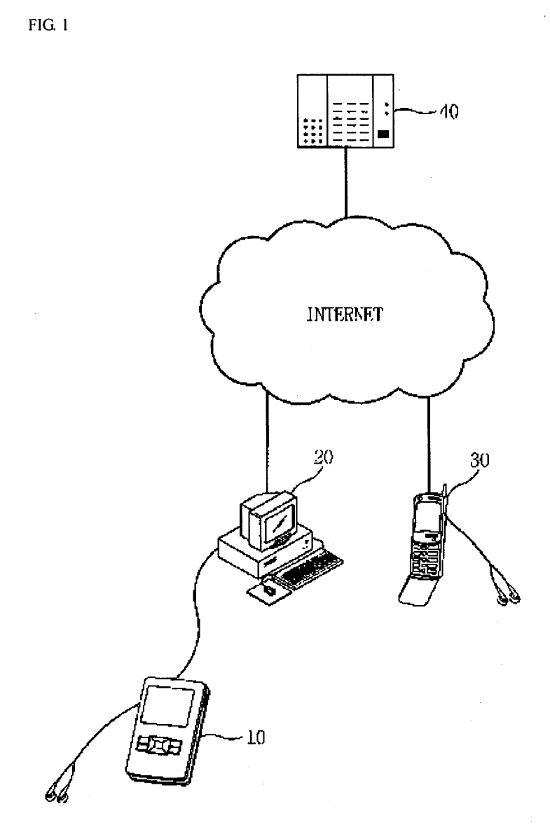

FIG. 1 illustrates an MP3 player automatic update system according to the present invention. The MP3 player automatic update system according to the present invention includes an MP3 player 10 for storing music files and creating a stored music list, an MP3 server 40 for updating and storing a plurality of music files and a music group list and providing music files via the Internet and an Internet terminal 20 for transmitting and receiving data to and from the MP3 player 10 and accessing the MP3 server 40 via the Internet.

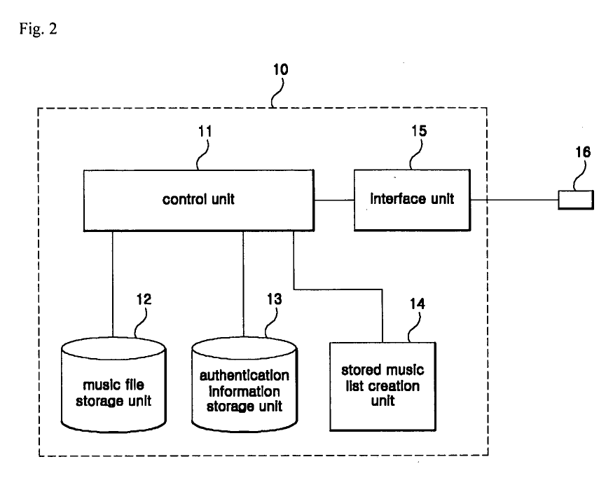

The MP3 player 10 includes a function to download music files, such as MP3 files, through communication with an external device, such as a computer and a function to create a stored music list and transmit the list via a connection unit 16 (refer to FIG. 2), such as a USB connector. The MP3 player 10 of the present invention is not limited to MP3 technology, but rather may be any device that includes a function to store data-type music files, such as WAV files, AU files, OGG files and MID files, other non-MP3 files, and to convert the music files into audio signals.

FIG. 2 illustrates the construction of the MP3 player 10. FIG. 2 illustrates only elements that are directly related to the construction of the present invention. Since the function for playing music and the function for providing a user interface are the same as in the conventional MP3 player, detailed descriptions of those functions are omitted.

A control unit 11 controls the overall operation of the MP3 player 10 and the music file storage unit 12, such as a flash Random Access Memory (RAM), stores music files downloaded by a user. A stored music list creation unit 14 creates a list of music files stored in the MP3 player 10 and a stored music list in coded data form that can distinguish one piece of music from another. An interface unit 15 and a connection unit 16 transmit data to and receive data from the Internet terminal 20 and support wireless interfaces, such as Bluetooth, as well as wired interfaces, such as a Universal Serial Bus (USB) connector.

Preferably, the MP3 player 10 includes an authentication information storage unit 13 to store authentication information that the user uses to access the MP3 server 40. A detailed description of the authentication information storage unit 13 will be given in conjunction with a description of the operational relationship between the elements.

The Internet terminal 20 refers to a device that can access the Internet via a communication network. Although the Internet terminal 20 is described with reference to a Personal Computer (PC), it is not limited to a PC and may be a Personal Digital Assistant (PDA), a mobile phone, a kiosk, or other similar device.

It is also contemplated that, given the recent development of information technology, a mobile phone 30 including an MP3 player function may be utilized, such that the function of the MP3 player 10 and the function of the Internet terminal 20 are combined. The mobile terminal 30 then corresponds to both the MP3 player 10 and the Internet terminal 20.

The MP3 server 40 is a general Internet server and stores a plurality of music files and transmits corresponding music files via the Internet at the request of users. Although the term MP3 server 40 is used for ease of description, the MP3 server 40 of the present invention is not limited to MP3 technology, but rather may be any server that can transmit various types of data music files, such as WAV files, AU files, OGG files and MID files, as well as MP3 files.

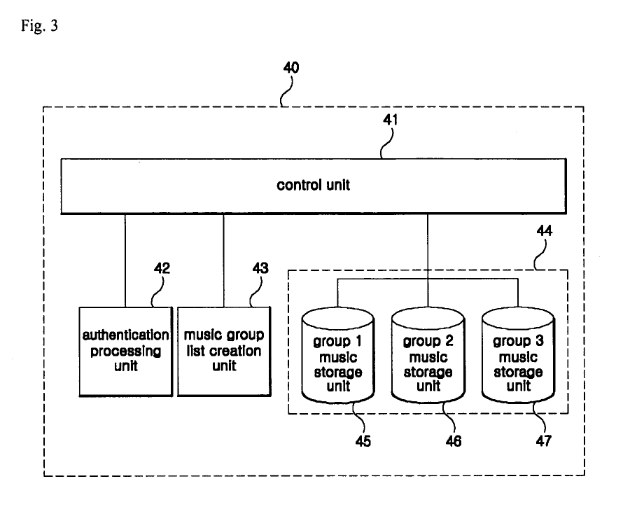

FIG. 3 illustrates the construction of the MP3 server 40 in more detail. FIG. 3 illustrates only elements that are directly related to the present invention. Since the function for communication network access is the same as that of a conventional Internet server, a detailed description is omitted. The control unit 41 controls the overall operation of the MP3 server 40. The authentication processing unit 42 authenticates the user or MP3 player 10 that accesses the MP3 server 40. The music file storage unit 44 stores music files provided by the server. The music group list creation unit 43 prepares and stores lists for respective music groups.

The music file storage unit 44 may be include a plurality of music storage units, for example group 1 music storage unit 45, group 2 music storage unit 46 and group 3 music storage unit 47. Music files stored in the music file storage unit 44 are updated, either regularly or irregularly, to new music by the administrator of the MP3 server 40 and the music group list creation unit 43 updates the music group lists for respective groups accordingly.

First, the Internet terminal 20 accesses the MP3 server 40 when the MP3 player 10 gains access. Unlike a method by which the user accesses a general Internet server, for the user's convenience it is preferred that the Internet terminal 20 automatically access the MP3 server upon detecting access by the MP3 player without a procedure to input the Uniform Resource Locator (URL) of the MP3 server 40 using the Internet terminal 20. For example, when the user's computer detects access by the MP3 player 10 via the USB connector, the computer may automatically access the URL of the MP3 server 40 using a previously installed program without the user additionally inputting a URL.

More preferably, as illustrated in FIG. 2, the MP3 player 10 may include an authentication information storage unit 13 for storing user authentication information that is used to access the MP3 server 40. The Internet terminal 20 not only automatically accesses the MP3 server 40 when the MP3 player 10 gains access, but also automatically receives user authentication information from the MP3 player 10 and transmits the user authentication information to the MP3 server 40. Accordingly, the user can obtain authentication from the MP3 server 40 at the time of general Internet server access without an inconvenient procedure, such as the input of a user ID or password.

When the MP3 player 10 accesses the MP3 server 40, a comparison is made between the stored music list created by the stored music list creation unit 14 of the MP3 player 10 and the music group list created by the music group list creation unit 43 of the MP3 server 40. The MP3 server selectively transmits only updated music files, or those files that are only in the music group list, to the MP3 player 30. Preferably, music files that are only in the stored music list may be deleted to ensure storage space in the MP3 player 10 for storage of updated music files.

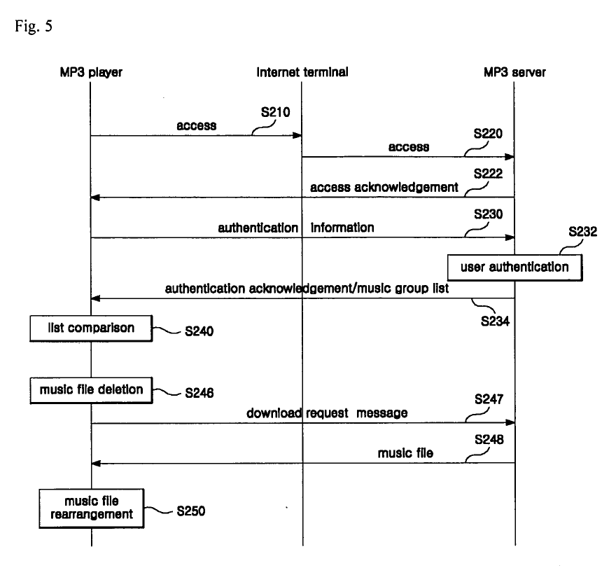

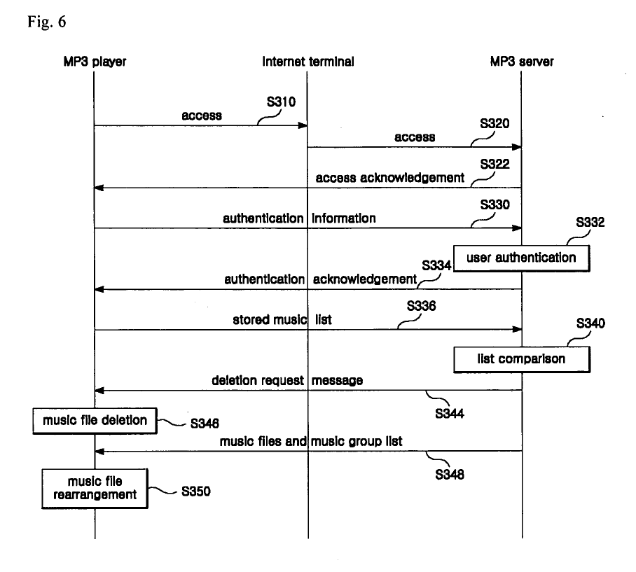

The flow of a transmitted signals varies depending on whether the comparison of the lists is performed by the MP3 player 10 or MP3 server 40. The differences in signal flow will be given in the descriptions of FIGS. 5 and 6.

Preferably, the MP3 player 10 rearranges the stored music files according to the order of the music group list after receiving the music files. For example, when the music group list provided by the MP3 server 40 is arranged in order of popularity, similar to a Billboard chart, the popularity ranking of the music included the list varies with time and the MP3 player 10 automatically rearranges the stored music in order of popularity whenever it accesses the MP3 server 40. As a result, the present invention enables the order of storing music files in the MP3 player and the order of playing music files stored in the MP3 player 10 to be synchronized with the order of recent popularity without the user having to perform a separate rearrangement process.

The MP3 server 40 may provide only a single music group list. However, it is preferred that a plurality of music group lists is stored and updated, a music group list selected by the user is stored as the user's information, and only the selected music group list is compared with the stored music list of the MP3 player when a user gains access.

The user may previously designate a preferred list from among a plurality of music group lists and the preferred list is stored as part of the user information so that only music suitable for the user's preferences will be provided thereafter. For example, lists classified according to genre, such as Rock, Jazz, and Ballads, or according to age may be designated.

In addition to a music group list created by the music group list creation unit 43 of the MP3 server 40, a music group list that was registered by a certain user and the announcement of which was requested thereafter, may be included in the music group lists provided by the MP3 server 40. That is, certain users using the MP3 server 40 of the present invention may register personal music group lists formed by collecting preferred pieces of music with the MP3 server 40 and request the announcement of the lists to other persons. Thereafter, another user previously designates a preferred personal music group list from among the announced personal music group lists and stores the preferred personal music group list as part of the user information such that only the music files corresponding to the designated personal music group list are updated.

When the stored music list and the music group list are compared, it is preferred that only legally distributed MP3 files be targeted for the comparison. This is because illegally reproduced MP3 files or MP3 files downloaded from illegal servers may disrupt order in the circulation of MP3 files and consistent comparison criteria may not be applied because the same pieces of music may have different file names or Identifications (IDs) depending on how the files were reproduced. In other words, since it is difficult for the MP3 server 40 to apply consistent comparison criteria to illegally reproduced MP3 files, it is impossible to determine where MP3 files targeted for update have been previously stored in the MP3 player 10.

More preferably, when comparison between the stored music list and the music group list is performed, Digital Rights Management (DRM)-enabled MP3 files can be targeted for the comparison, thereby facilitating the use of copyright information stored in the MP3 files, unique serial numbers, or IDs assigned at the time of creating the MP3 files as a basis for comparison. DRM is a management technique of inserting various types of copyright information into digital content in order to prevent the illegal distribution and reproduction of digital content and provide proper profits to copyright holders.

DRM-enabled digital content must undergo a copyright authentication process at the time of use even after it has been reproduced. Accordingly, the basis and criterion of the comparison of music files may be clarified and remain consistent when one or more of various types of unique information contained in DRM-enabled MP3 files are used for the comparison.

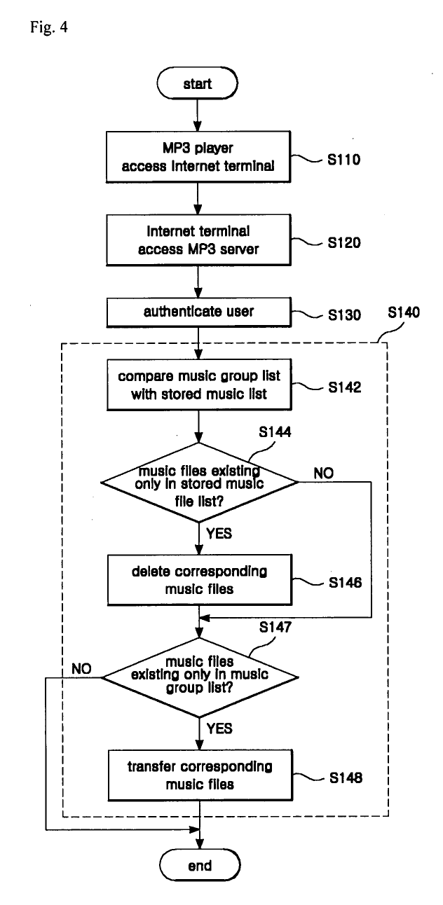

FIG. 4 illustrates a method of automatically updating an MP3 player in accordance with an embodiment of the present invention. First, the MP3 player 10 accesses an Internet terminal 20 (S110). This access may be achieved in a wired or wireless manner. A device combining the functions of the MP3 player 10 and the Internet terminal 20 does not undergo a separate access step.

Next, the Internet terminal 20 accesses the MP3 server 40 via a communication network, such as the Internet (S120). It is preferred that the Internet terminal 20 automatically access the MP3 server 40 upon detecting access by the MP3 player 10 in step S110.

Thereafter, the MP3 server 30 authenticates the user (S130). It is preferable to authenticate the user by automatically transferring authentication information, which was previously stored in the MP3 player 10, to the MP3 server 40 via the Internet terminal 20.

Finally, the music group list updated in the MP3 server 40 is compared with the stored music list stored in the MP3 player 10 (S140, S144, S147) and those music files that are only in the music group list are selectively transferred from the MP3 server 40 to the MP3 player 10 (S148). It is preferred that music files that are determined as only in the stored music list are selectively deleted from the music file storage unit 12 of the MP3 player 10 (S146), thereby ensuring storage space for music files to be transferred. Furthermore, when the update of music files is completed, it is preferred that the order of storage of the music files stored in the MP3 player 10 be rearranged according to the order of the music group list.

FIG. 5 illustrates a signal processing diagram for the comparison of the music group list and the stored music list performed by the MP3 player 10 in accordance with a first embodiment of the present invention. When the MP3 player 10 accesses the Internet terminal 20 (S210) and the Internet terminal 20 accesses the MP3 server 40 (S220), the MP3 server 40 transfers an access acknowledgement message to the MP3 player 10 (S222).

The MP3 player 10 transfers previously stored authentication information to the MP3 server 40 in response to the access acknowledgement message (S230) and the MP3 server 40 authenticates the user by determining whether the authentication information matches the user information stored in the MP3 server 40 (S232).

If the user authentication is successful, the MP3 server 40 transfers the music group list to the MP3 player 10 along with the authentication acknowledgement message (S234) and the MP3 player 10 compares the music group list with the stored music list of the MP3 player 10 (S240). The MP3 player 10 deletes music files that are determined as only in the stored music list (S246), creates a download request message for the music files determined as only in the music group list and transfers the download request message to the MP3 server 40 (S247).

The MP3 server 40 transfers only music files requested by the download request message to the MP3 player 10 (S248) and the MP3 player 10 rearranges the order of the storage of the stored music files according to the order of the music group list after the completion of the transmission (S250).

FIG. 6 illustrates a signal processing diagram for the comparison of the music group list and the stored music list performed by the MP3 server 40 in accordance with a second embodiment of the present invention. When the MP3 player 10 accesses the Internet terminal 20 (S310) and the Internet terminal 20 accesses the MP3 server 40 (S320), the MP3 server 40 transfers an access acknowledgement message to the MP3 player 10 (S322).

The MP3 player 10 transfers previously stored authentication information to the MP3 server 40 in response to the access acknowledgement (S330) and the MP3 server 40 authenticates the user by determining whether the authentication information matches the user information stored in the MP3 server 40 (S332).

If the user authentication is successful, the MP3 server 40 transfers an authentication acknowledgement message (S334) and the MP3 player 10 transfers the stored music list to the MP3 server 40 in response to the authentication acknowledgement message (S336). The MP3 server 40 compares the received music group list with the stored music list of the MP3 player 10 (S340). The MP3 server 40 creates a deletion request message for music files determined as only in the stored music list and transfers the deletion request message to the MP3 player 10 (S344) and the MP3 player 10 deletes corresponding music files in response to the deletion request message (S346). The MP3 server 40 selectively transfers those music files determined as only in the music group list to the MP3 player 10 (S348). When the transmission is completed, the MP3 server 40 transfers the music group list to the MP3 player 10 and the MP3 player 10 rearranges the order of the storage of the stored music files according to the received music group list (S350).

As described herein, the MP3 player and the system and method for automatically updating the MP3 player are advantageous in that they can update the music files of the MP3 player to new music using the server without the inconvenience of the user having to search for or produce desired music files using a computer and then download the music files to the MP3 player. The preferred embodiment of the present invention is advantageous in that, if a user connects the MP3 player to the Internet terminal, such as a PC, the MP3 server access process, the user authentication process, the new music search process and the new music update process are automatically performed. Another embodiment of the present invention is advantageous in that the user's preferences for music can be stored as part of the user information and an update is performed only of the user's preferred music. Finally, still another embodiment of the present invention is advantageous in that the order of storage or playing of music files stored in the user's MP3 player can be synchronized with the ranking of current popularity of music.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A system for automatically updating a device capable of storing data-type music files, the system comprising:
an server adapted to update and store a plurality of music files and a music group list of the plurality of music files and to transfer at least one music file of the plurality of stored music files over the Internet; and
a playback device adapted to store the at least one music file and create a stored music list of stored music files,
wherein the at least one music file is selected according to a comparison between the playback device stored music list and the server music group list such that the at least one music file is not presently in the playback device stored music list.

2. The system as set forth in claim 1, wherein the playback device is a Moving Picture Experts Group-1 Audio Layer-3 (MP3) player and the server is an MP3 server.

3. The system as set forth in claim 2, wherein the music files are Digital Rights Management (DRM)-enabled MP3 music files and the comparison is performed based on at least one of unique serial numbers assigned to the music files for DRM support and Identification (ID) information.

4. The system as set forth in claim 1, further comprising an Internet terminal adapted to transfer data to and from the playback device and access the server via the Internet.

5. The system as set forth in claim 4, wherein the playback device comprises an authentication information storage unit adapted to store user authentication information used to access the server.

6. The system as set forth in claim 5, wherein the Internet terminal is further adapted to automatically transfer the user authentication information to the server upon the playback device gaining access.

7. The system as set forth in claim 1, wherein the playback device is further adapted to perform the comparison after receiving the music group list from the server.

8. The system as set forth in claim 7, wherein:
the playback device is further adapted to create and transfer a transfer request message to the server, the transfer request message indicating the at least one music file that is not presently in the playback device stored music list; and
the server is further adapted to receive the transfer request message and transfer the indicated at least one music file to the playback device.

9. The system as set forth in claim 7, wherein the playback device is further adapted to automatically delete at least one music file according to the comparison, the at least one music file presently in the playback device stored music list but not presently in the received server music group list.

10. The system as set forth in claim 1, wherein the server is further adapted to perform the comparison after receiving the stored music list from the playback device and transfer the at least one music file that is not presently in the playback device stored music list to the playback device.

11. The system as set forth in claim 10, wherein:
the server is further adapted to create and transfer a delete request message to the playback device, the delete request message indicating at least one music file according to the comparison, the at least one music file presently in the received playback device stored music list but not presently in the server music group list; and
the playback device is further adapted to receive the delete request message and delete the indicated at least one music file.

12. The system as set forth claim 1, wherein the server is further adapted to update the stored music group list, receive and store a music group list previously registered by the user as part of user information, and compare the previously registered music group list with the stored music group list.

13. The system as set forth in claim 1, wherein the playback device is further adapted to rearrange at least one of an order of storing music files and an order of playing music files according to the server music group list.

14. A method of automatically updating a device capable of storing data-type music files, the method comprising:
a playback device accessing a server over the Internet;
comparing a music group list stored in the server with a music list stored in the playback device; and
the server transferring at least one music file to the playback device, the at least one music file selected from a plurality of music files stored in the server,
wherein the at least one music file is selected according to the comparison such that the at least one music file is not presently in the playback device stored music list.

15. The method as set forth in claim 14, wherein the playback device accessing the server further comprises:
the playback device accessing an Internet terminal;
the Internet terminal detecting access by the playback device, retrieving user authentication information stored in the playback device and transferring the authentication information to the server; and
the server receiving the authentication information and automatically authenticating a user using the authentication information.

16. The method as set forth in claim 14, wherein the music files are DRM-enabled MP3 files and the comparing is performed based on at least one of unique serial numbers assigned to the music files for DRM support and ID information.

17. The method as set forth in claim 14, further comprising:
the server transferring the music group list to the playback device;
the playback device performing the comparison and creating and transferring a transfer request message to the server, the transfer request message indicating the at least one music file that is not presently in the playback device stored music list; and
the server receiving the transfer request message and transferring the indicated at least one music file to the playback device.

18. The method as set forth in claim 17, further comprising the playback device automatically deleting at least one music file according to the comparison, the at least one music file presently in the playback device stored music list but not presently in the received server music group list.

19. The method as set forth in claim 14, further comprising:
the playback device transferring the stored music list to the server; and
the server performing the comparison and transferring the at least one music file that is not presently in the playback device stored music list to the playback device.

20. The method as set forth in claim 19, further comprising:
the server creating and transferring a delete request message to the playback device, the delete request message indicating at least one music file according to the comparison, the at least one music file presently in the received playback device stored music list but not presently in the server music group list; and
the playback device receiving the delete request message and deleting the indicated at least one music file.

21. The method as set forth in claim 14, further comprising the server updating the stored music group list, receiving and storing a music group list previously registered by the user as part of user information, and comparing the previously registered music group list with the stored music group list.

22. The method as set forth in claim 14, further comprising the playback device rearranging at least one of an order of storing music files and an order of playing music files according to the server music group list.

23. The system as set forth in claim 14, wherein the playback device is a Moving Picture Experts Group-1 Audio Layer-3 (MP3) player and the server is an MP3 server.

24. An playback device capable of storing data-type music files, the playback device comprising:
a music file storage unit adapted to store the music files;
a server access unit adapted to access a server over the Internet;
a stored music list creation unit adapted to create a stored music list comprising a list of music files stored in the music file storage unit; and
an update unit adapted to receive at least one music file from the server, the at least one music file selected from a plurality of music files stored in the server according to a comparison of a music group list stored in the server with the stored music list such that the at least one music file is not presently in the stored music list.

25. The playback device as set forth in claim 24, further comprising an Internet terminal connection unit adapted to access an Internet terminal, the Internet terminal adapted to transfer data to and from the playback device and access the server via the Internet.

26. The playback device as set forth in claim 25, further comprising an authentication information storage unit adapted to store user authentication information that is used to access the server and wherein the Internet terminal automatically retrieves and transfers the user authentication information to the server when the Internet terminal connection unit device gains access.

27. The playback device as set forth in claim 24, wherein the music files are DRM-enabled MP3 files and the comparison is performed based on at least one of unique serial numbers assigned to the music files for DRM support and ID information.

28. The playback device as set forth in claim 24, wherein the update unit comprises:
a music file comparison unit adapted to receive the music group list from the server, compare the music group list with the stored music list and detect the at least one music file that is not presently in the stored music list; and
a download request message creation unit adapted to create and transfer a transfer request message to the server, the transfer request message indicating the at least one music file that is not presently in the stored music list.

29. The playback device as set forth in claim 28, wherein the update unit further comprises an automatic music file deletion unit adapted to automatically delete at least one music file according to the comparison, the at least one music file presently in the stored music list but not presently in the music group list.

30. The playback device a set forth in claim 24, wherein the update unit is further adapted to automatically receive the at least one music file that is not presently in the stored music list from the server upon the server performing the comparison.

31. The playback device as set forth in claim 30, wherein the update unit further comprises an automatic music file deletion unit adapted to receive a deletion request message from the server, the delete request message indicating at least one music file presently in the stored music list but not presently in the music group list and to delete the indicated at least one music file.

32. The playback device as set forth in claim 24, wherein the music file storage unit is further adapted to rearrange at least one of an order of storing music files and an order of playing music files according to an updated music group list from the server.
